(19) United States
(12) Patent Application Publication
(10) Pub. No.: US 2016/0062698 A1
(43) Pub. Date: Mar. 3, 2016

(54) STORAGE DEVICE CONTROLLER ARCHITECTURE

(71) Applicant: Marvell World Trade Ltd., St. Michael (BB)

(72) Inventor: Zining Wu, Los Altos, CA (US)

(21) Appl. No.: 14/829,838

(22) Filed: Aug. 19, 2015

Related U.S. Application Data
(60) Provisional application No. 62/041,909, filed on Aug. 26, 2014.

(51) Int. Cl. G06F 3/06; G06F 11/07

(52) U.S. Cl. CPC G06F 3/0647; G06F 3/061; G06F 3/0683; G06F 11/0793; G06F 11/073

(57) ABSTRACT

Data storage apparatus includes a plurality of drive units, each of the drive units including a plurality of memory channels, and a plurality of storage medium controllers. Each storage medium controller addresses at least one of the memory channels. Each of the storage medium controllers is incapable of performing file system operations. An integrated storage controller connected to each of the drive units performs all file system operations of the data storage apparatus. The integrated storage controller includes a central processing unit, a host interface, and at least one storage medium interface for communicating with the plurality of storage medium controllers. A method for operating such data storage apparatus includes performing, in the integrated storage controller, error correction across all of the memory channels, as well as redundancy and wear-leveling. Each storage medium controller may perform error correction across all of the memory channels addressed by that controller.

### CROSS REFERENCE TO RELATED APPLICATION

This claims the benefit of copending, commonly-assigned U.S. Provisional Patent Application No. 62/041,909, filed Aug. 26, 2014, which is hereby incorporated by reference herein in its entirety.

### FIELD OF USE

This disclosure relates to a controller architecture for controlling multiple storage devices.

### BACKGROUND

The background description provided herein is for the purpose of generally presenting the context of the disclosure. Work of the inventors hereof, to the extent the work is described in this background section, as well as aspects of the description that may not otherwise qualify as prior art at the time of filing, are neither expressly nor impliedly admitted to be prior art against the present disclosure.

A data storage device such as a disk drive, as well as a solid-state drive, communicates with a host system through a storage controller. In many cases, a large number of drives present themselves to the host as a single drive system. Such a collection of drives typically includes a large number of controllers, giving rise to inefficiencies.

### SUMMARY

Data storage apparatus in accordance with implementations of this disclosure includes a plurality of drive units, each of the drive units including a plurality of memory channels, and a plurality of storage medium controllers. Each storage medium controller addresses at least one of the memory channels. Each of the storage medium controllers is incapable of performing file system operations. An integrated storage controller connected to each of the drive units performs all file system operations of the data storage apparatus.

An integrated storage controller, in accordance with implementations of this disclosure, controls a plurality of drive units, where each drive unit includes a plurality of memory channels, and a plurality of storage medium controllers, each storage medium controller addresses at least one of the memory channels, and each of the storage medium controllers is incapable of performing file system operations. The integrated storage controller includes a central processing unit, a host interface, and at least one storage medium interface for communicating with the plurality of storage medium controllers. The integrated storage controller performs all file system operations of the data storage apparatus.

A method according to implementations of this disclosure, for operating data storage apparatus having a plurality of drive units, where each of the drive units includes a plurality of memory channels and a plurality of storage medium controllers, each storage medium controller addressing at least one of the memory channels, and each of the storage medium controllers being incapable of performing file system operations, includes performing all file system operations of the data storage apparatus in an integrated storage controller connected to all of the drive units, and performing, in the integrated storage controller, error correction across all of the memory channels.

Such a method also may include performing, in each storage medium controller, error correction across all of the at least one of the memory channels addressed by that controller.

In addition, in such a method, performing error correction across all of the memory channels may include redundancy, whereby the data storage apparatus is operable in case of failure of one of the memory channels.

Such a method also may include performing, in the integrated storage controller, wear-leveling across all of the memory channels.

### BRIEF DESCRIPTION OF THE DRAWINGS

Further features of the disclosure, its nature and various advantages, will be apparent upon consideration of the following detailed description, taken in conjunction with the accompanying drawings, in which like reference characters refer to like parts throughout, and in which:

FIG. 1 shows an arrangement of solid-state drives under the SAS protocol;

FIG. 2 shows an arrangement of solid-state drives under the PCIe protocol;

FIG. 3 shows one distribution of software processes across systems such as those shown in FIGS. 1 and 2;

FIG. 4 shows a storage architecture in accordance with an implementation of this disclosure;

FIG. 5 shows details of a storage controller in accordance with an implementation of this disclosure;

FIG. 6 shows details of a memory channel controller in accordance with an implementation of this disclosure;

FIG. 7 shows one distribution of software processes across systems in accordance with implementations of this disclosure; and

FIG. 8 is a flow diagram of a method in accordance with this disclosure.

### DETAILED DESCRIPTION

As discussed above, in many cases, a large number of storage devices present themselves to a host system as a single storage device. Such a collection of drives or devices typically includes a large number of controllers, giving rise to inefficiencies. In accordance with implementations of this disclosure, those inefficiencies may be mitigated by simplifying the controller architecture.

An array of storage devices such as disk drives or solid-state drives may be connected to a host system according to various protocols, including, e.g., the Serial-Attached SCSI Small Computer System Interface (also known as Serial-Attached SCSI or simply SAS), or the Peripheral Component Interconnect Express (also known as PCI Express or simply PCIe).

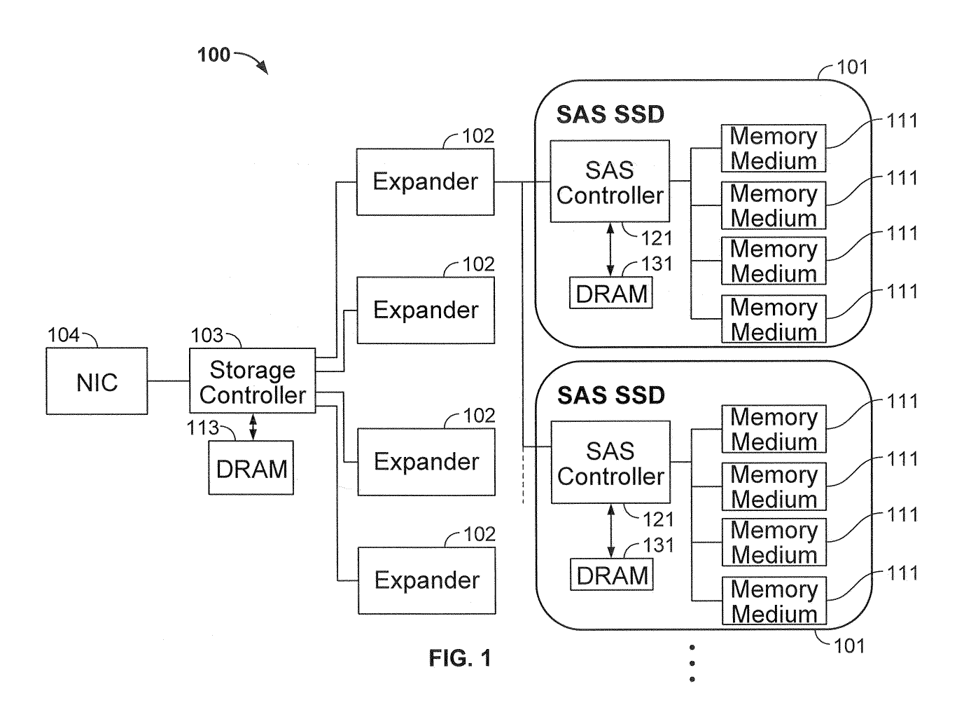

FIG. 1 shows an arrangement 100 of solid-state drives (SSDs) 101 under the SAS protocol. Each SSD 101 includes a plurality (in this example, four) solid-state memory channels 111. For example, each memory channel 111 may be a memory medium such as a single NAND Flash memory chip or die. Memory channels 111 are controlled by a SAS controller 121, which uses working memory (e.g., DRAM) 131.

Although only two SSDs 101 are shown, a larger number of SSDs 101 may be connected together by each expander 102. Expander 102 is a fan-out device that connects to storage controller 103. Storage controller 103 interfaces with the host system. In this example of an enterprise storage system, the host system is a network, to which storage controller 103 is connected by a network interface card (NIC) 104.

Typically, storage controller 103 is based on an x86-class central processing unit (CPU), and uses working memory (e.g., DRAM) 113. Storage controller 103 may include a specialized interface card that allows it to connect to, e.g., four expanders 102. Expanders 102 may be cascaded, allowing, e.g., 128 SSDs 101 to be connected to a single storage controller 103 (such arrangements are sometimes referred to as JBOD, for “just a bunch of drives”) if each expander 102 is cascaded with four additional expanders (not shown).

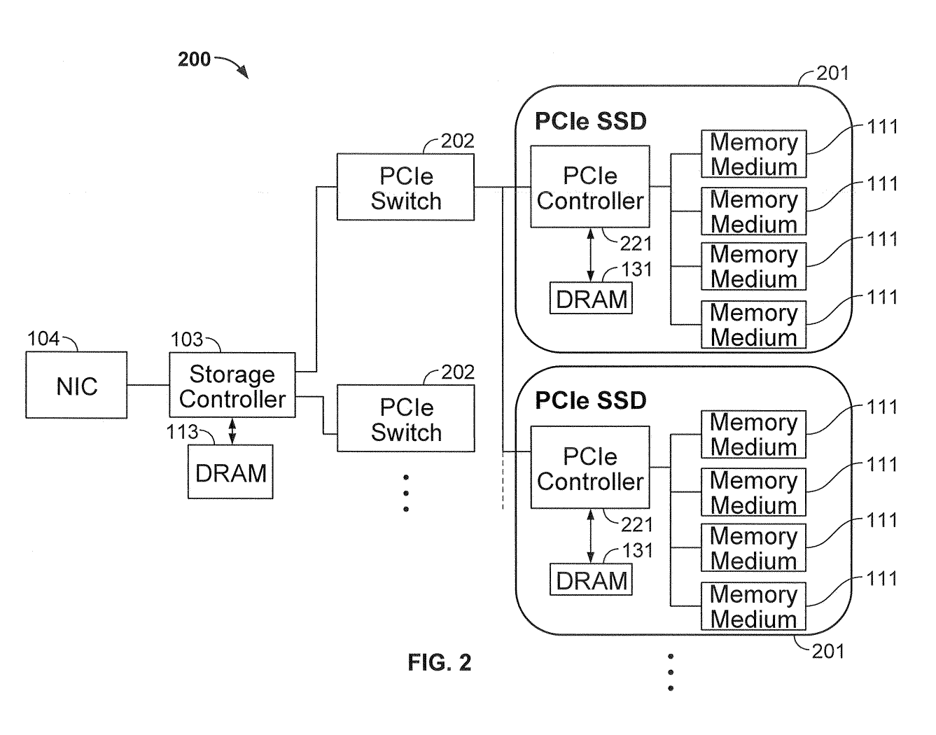

FIG. 2 shows an arrangement 200 of solid-state drives (SSDs) 201 under the PCIe protocol. Each SSD 201 includes a plurality (in this example, four) solid-state memory channels 111. For example, each memory channel 111 may be a memory medium such as a single NAND Flash memory chip or die. Memory channels 111 are controlled by a PCIe controller 221, which uses working memory (e.g., DRAM) 131.

A plurality of SSDs 201 may be connected together by PCIe switches 202, which serve a function similar to that of expanders 102, to connects to storage controller 103. Storage controller 103 interfaces with the host system. In this example of an enterprise storage system, the host system is a network, to which storage controller 103 is connected by a network interface card (NIC) 104.

PCIe-based arrangement 200 may interface more easily with storage controller 103 than SAS-based arrangement 100 because PCIe is more nearly “native” to the CPU of storage controller 103. However, both arrangements introduce inefficiencies. For example, SSD controllers 121, 221 are nearly as complex as storage controller 103, and both storage controller 103 and SSD controllers 121, 221 use working memory 113, 131. And all of the controller components and working memories add to system expense.

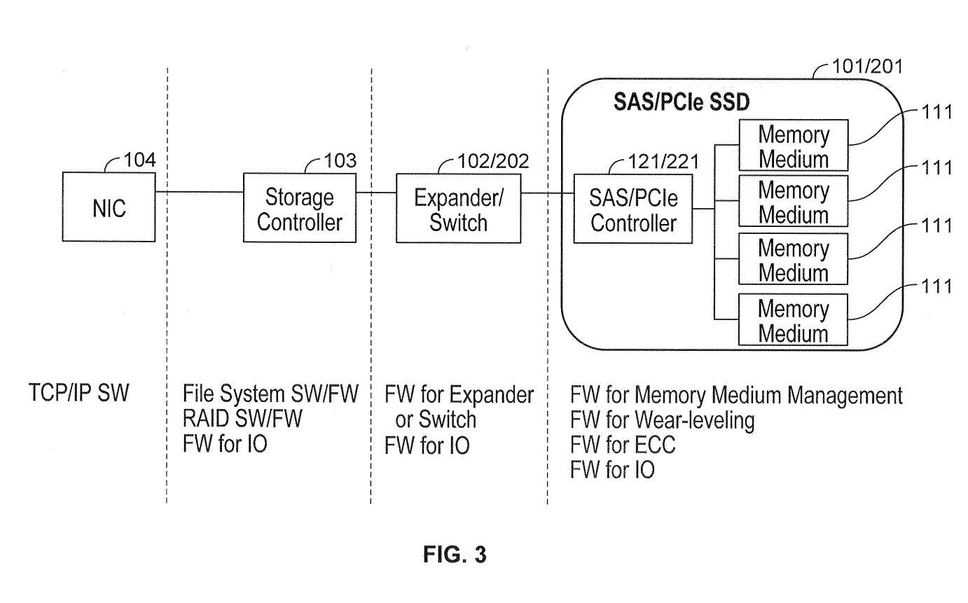

The inefficiencies may be more apparent from the software perspective, illustrated in FIG. 3. As seen, network interface card 104 runs TCP/IP or other networking software. Storage controller 103 runs software or firmware to control the file system—i.e., the allocation of files, or portions of files, to locations on the various memory channels 111. Storage controller 103 also may run RAID-type redundancy software or firmware to control allocation of portions of files to the various memory channels 111 to provide redundancy so that the system remains operable if one of memory channels 111 fails, and also runs input/output firmware to allow communication with both network interface card 104 and expanders/switches 102, 202. Each expander/switch 102, 202 runs its own firmware, as well as input/output firmware to allow communication with both storage controller 103 and SSDs 101, 201.

Finally, the SAS or PCIe controller 121, 221 in each SSD 101, 201 runs firmware (or software) for several processes. First, there is firmware for controlling the reading from and writing to memory channels 111, at least partially duplicating the file system functions of storage controller 103. Second, there is firmware to control wear leveling (a technique to prolong the life of the memory media by assuring that each cell in a Flash memory is written to roughly the same number of times as each other cell). Third, there is firmware for error correction (ECC). Finally, there is input/output firmware to allow communication with expander/switch 102, 202.

The need to run all of the software described above is at least part of the reason for the presence of working memory 131. In addition, protocol translation is needed between the internal protocol of storage controller 103 (e.g., Advanced eXtensible Interface, or AXI) and the PCIe and/or SAS protocols. And expanders 102 or switches 202 are relatively expensive.

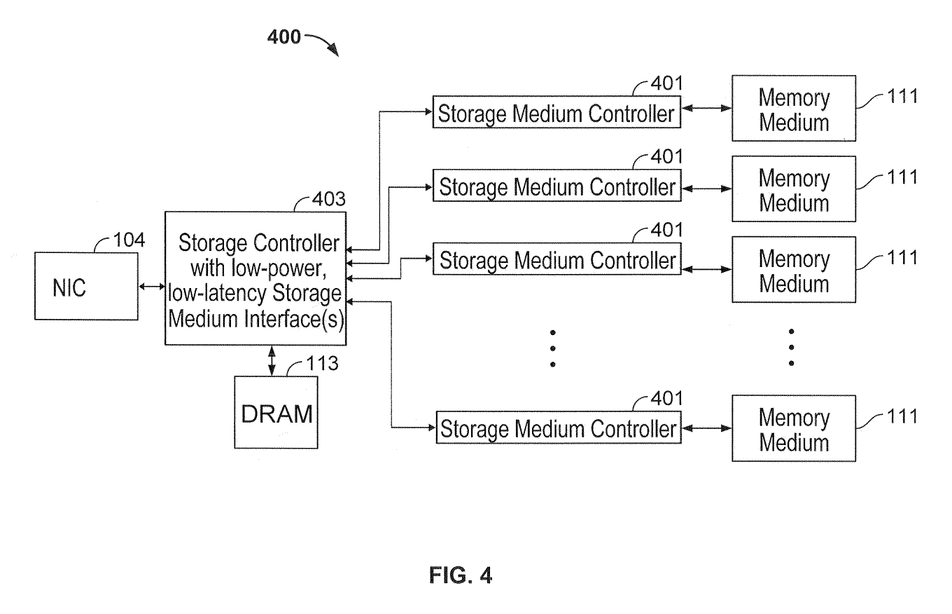

The efficiency of a storage device array, and particularly a solid-state drive array, may be improved according to implementations of this disclosure, as shown, e.g., in FIGS. 4-7, using a low-power, low-latency interface.

According to implementations of this disclosure, the functions of SAS controller 121 or PCIe controller 221, each of which controls multiple memory channels 111, are replaced by storage medium controllers, each of which controls a small number of storage medium channels 111 (e.g., one or two storage medium channels 111). Many of the functions of SSD controllers 121, 221 are moved into a modified storage controller, as discussed below. The modified storage controller also eliminates the need for SAS expanders 102 or PCIe switches 202.

An overall architecture 400 in accordance with implementations of this disclosure is shown in FIG. 4. Each memory channel 111 (which may be NAND Flash memory, but potentially can be other types of memory media), or possibly two memory channels 111 (not shown), are controlled by a single storage medium controller 401. Each storage medium controller 401 is a simplified controller that controls the reading and writing to the storage medium in memory channel 111, and may include low-level hardware-based error correction functions.

Each storage medium controller 401 is connected directly to a storage controller 403. Storage medium controllers 401 may be connected to storage controller 403 by low-power, low-latency interfaces (LPLLI) which may be implemented using any desired serial interface, including, but not limited to, industry-standard serial interfaces (e.g., PCIe, LVDS, UFS, etc.). Storage controller 403 performs all of the file system functions of storage architecture 400—i.e., all manipulations associated with determining a particular location on one of memory channels 111 for storage of particular data from the host system. The individual storage medium controllers 401 do not perform any file system operations and control only the physical transfer of data to or from locations determined by storage controller 403. Storage controller 403 also performs wear-leveling functions, RAID-type redundancy functions if used, and error correction functions.

In one exemplary implementation, low-level on-the-fly ECC is performed by storage medium controllers 401, while high-level ECC (e.g., error recovery schemes involving re-reading data from storage media, or ECC schemes spanning all of memory channels 111) is performed by storage controller 403. In another exemplary implementation, all ECC functions are performed by storage controller 403, while the storage medium controllers 401 manage only commands (e.g., read, write, erase, trim, etc.) to the storage media and perform data transfer between the storage media and storage controller 403.

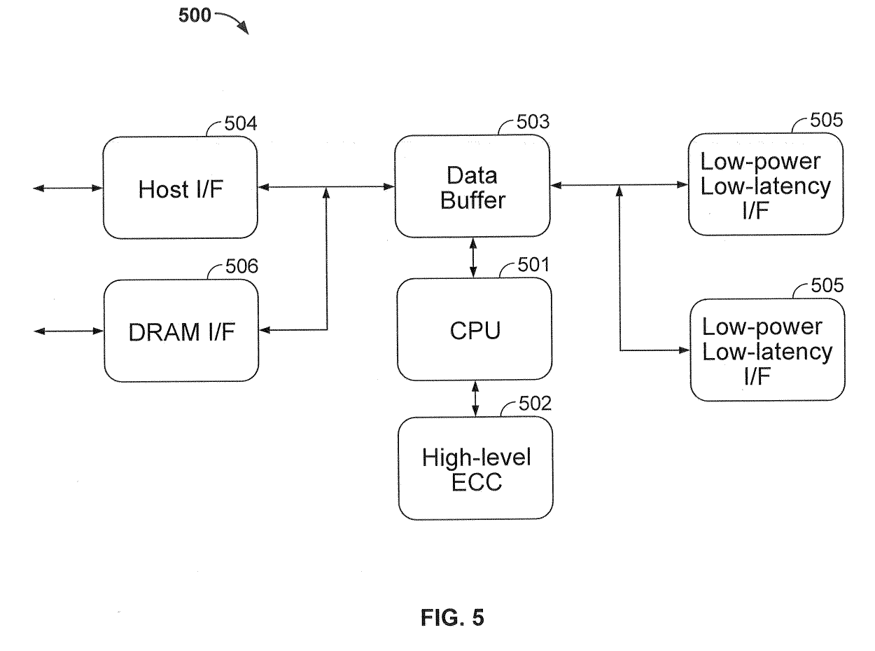

FIG. 5 shows detail of an implementation 500 of storage controller 403. According to this implementation 500, storage controller 403 includes a CPU 501, high-level ECC circuitry 502 (which may include RAID-type redundancy functionality) and a data buffer 503. Through data buffer 503, a host interface 504 connects CPU 501 to the host system (which may be NIC 104). Also through data buffer 503, one or more low-power, low-level interfaces 505 connect CPU 501 to memory channels 111. CPU 501 is thus able to perform all file system functions, translating between host data addresses and individual physical memory locations. To perform these file system functions, as well as error correction functions, CPU 501 may need access to DRAM 113 (see FIG. 4), and therefore a DRAM interface 506 also is connected to data buffer 503.

Each low-power, low-level interface 505 is capable of connection to a large number—e.g., 32 or 64—storage medium controllers 401. Therefore, depending on the number of low-power, low-level interfaces 505 that are provided, storage controller 403 can control 64, 96, 128, or more, storage medium controllers 401.

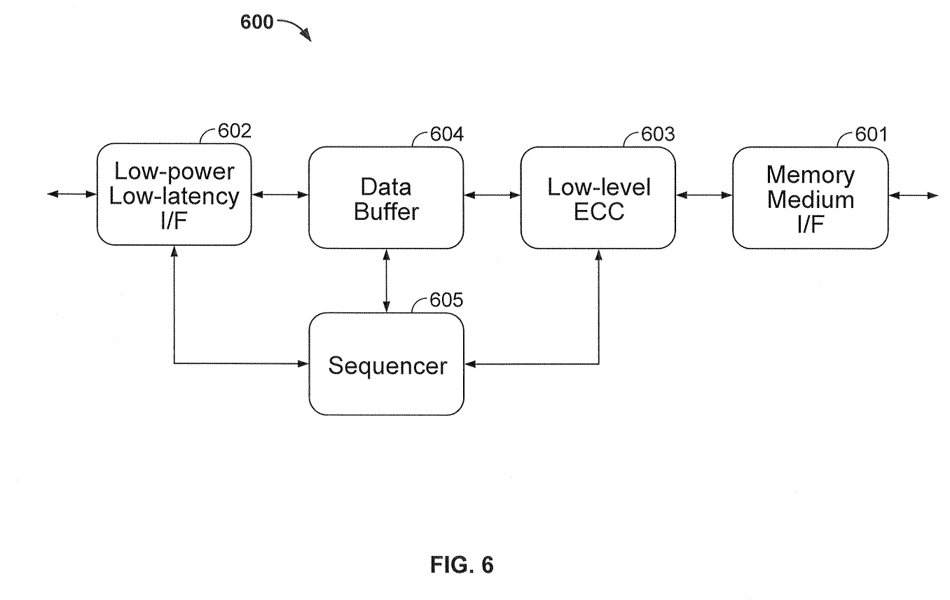

An implementation 600 of a storage medium controller 401 according to this disclosure is shown in FIG. 6. Storage medium interface 601 controls reading, writing, erasing, etc. of one or two memory channels 111. A low-power, low-level interface 602, similar to low-power, low-level interface 505 (except in the number of connections it supports) receives requests, including data and address information, from storage controller 403 via a serial or parallel interface. A serial interface is preferred to reduce the number of wires or pins needed.

Because it does not perform high-level ECC or redundancy functions, or file system address translations, storage medium controller 401 can be much simpler than SAS or PCIe controller 121, 221, and does not need extra memory such as DRAM 131. In this example, storage medium controller 401 does include low-level hardware ECC 603 as discussed above, as well as data buffer 604 and sequencer 605, which issues commands (e.g., read page, write page, erase block, etc.) to the storage media and keeps track of command status.

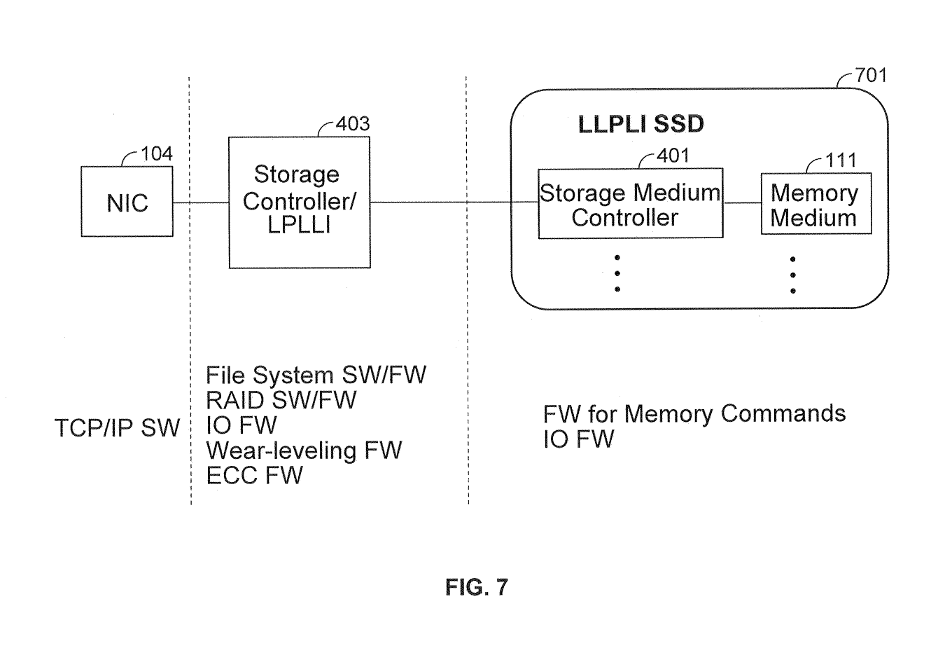

The improved efficiency of a storage controller architecture in accordance with this disclosure can be seen in FIG. 7 which, like FIG. 3, shows the software requirements for various components of the storage controller architecture. As in FIG. 3, network interface card 104 runs TCP/IP or other networking software. Each storage medium controller 401 in each solid-state drive unit 701 (which may include a plurality of storage medium controllers 401, each paired with one or two memory media 111) runs only firmware for memory commands (read, write, erase, etc.), as well as input/output firmware. The majority of the software required by architecture 400 is centralized in storage controller 403, which runs software or firmware to control the file system, as well as wear-leveling firmware to protect the storage media as above. Storage controller 403 also may run redundancy software or firmware to control allocation of portions of files to the various memory channels 111 to provide redundancy if one of memory channels 111 fails, and also runs input/output firmware to allow communication with both network interface card 104 and storage medium controller(s) 401.

While network interface card 104 and LPLLI storage controller 403 are shown as separate items, they could be provided together. In such a case, the storage system (not shown) would then include a single combined storage controller/network interface (not shown), along with one more solid-state drive units 701 (which may include a plurality of storage medium controllers 401, each paired with one or two memory media 111).

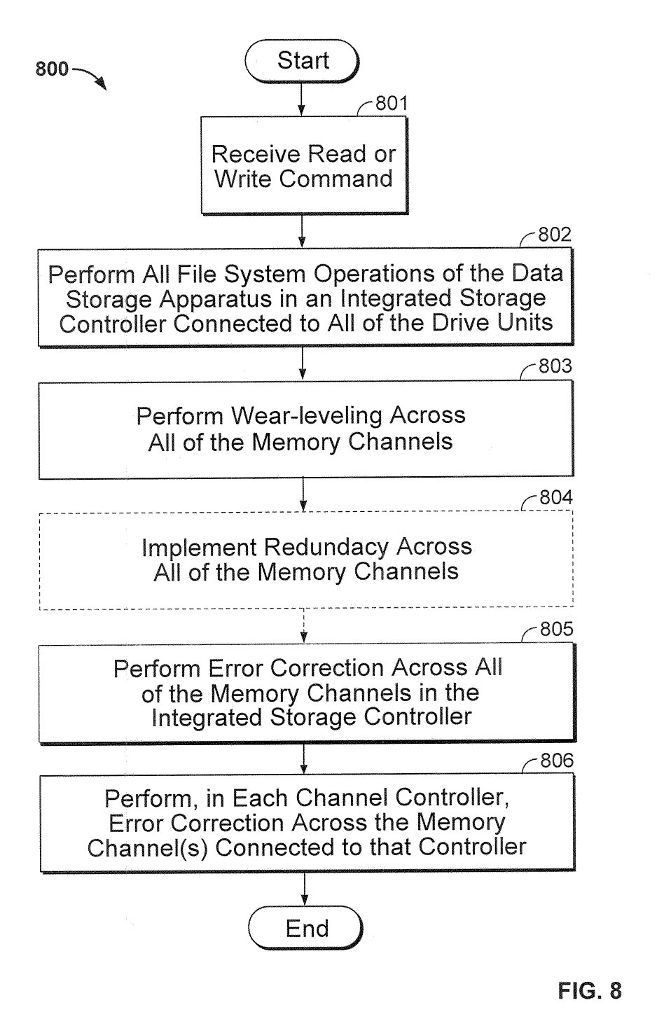

An implementation 800 of a method of operating such a system is diagrammed in FIG. 8. Method 800 begins at 801 where a read or write command is received from a host system. At 802, all file system operations used to carry out the read or write command in the data storage apparatus or system are performed in an integrated storage controller connected to all of the drive units in the system. At 803, wear-leveling is performed across all of the memory channels used to carry out a write command. At 804, redundancy is implemented across all of the memory channels used to carry out a write command. At 805, error correction is performed in the integrated storage controller across all of the memory channels used to carry out the read or write command. The redundancy at 804 may be implemented as part of the error correction at 805.

The operation performed at 804 is optional, although it is to be expected that that operation would be performed in connection with a write operation in any system in accordance with this disclosure.

At 804, redundancy is implemented across all of the memory channels used to carry out a write command. This may be performed as part of the error correction at 803. At 805, wear-leveling is performed across all of the memory channels used to carry out a write command.

At 806, error correction is performed, in each channel controller used to carry out the read or write command, across the memory channel or channels connected to that controller and used to carry out the read or write command, and method 800 ends.

It will be understood that the foregoing is only illustrative of the principles of the invention, and that the invention can be practiced by other than the described embodiments, which are presented for purposes of illustration and not of limitation, and the present invention is limited only by the claims which follow.

What is claimed is:

1. Data storage apparatus comprising:
a plurality of drive units, each of the drive units including:
a plurality of memory channels, and
a plurality of storage medium controllers, each storage medium controller addressing at least one of the memory channels, each of the storage medium controllers being incapable of performing file system operations; and
an integrated storage controller connected to each of the drive units, the integrated storage controller performing all file system operations of the data storage apparatus.

2. The data storage apparatus of claim 1 wherein each of the storage medium controllers addresses up to two of the memory channels.

3. The data storage apparatus of claim 1 wherein the integrated storage controller comprises:
a central processing unit;
a host interface; and
at least one storage medium interface for communicating with the plurality of storage medium controllers.

4. The data storage apparatus of claim 3 wherein the at least one storage medium interface comprises a plurality of storage medium interfaces.

5. The data storage apparatus of claim 3 wherein the integrated storage controller further comprises error correction circuitry that performs error correction across all of the memory channels.

6. The data storage apparatus of claim 5 wherein the error correction circuitry includes redundancy circuitry, whereby the data storage apparatus is operable in case of failure of one of the memory channels.

7. The data storage apparatus of claim 3 further comprising working memory for use by the central processing unit; wherein:
the integrated storage controller further comprises a working memory interface.

8. The data storage apparatus of claim 1 wherein the integrated storage controller performs wear-leveling across all of the memory channels.

9. The data storage apparatus of claim 1 wherein each of the storage medium controllers comprises:
a memory medium interface controlling reading data from, and writing data to, the at least one of the memory channels; and
a controller interface that communicates with the integrated storage controller.

10. The data storage apparatus of claim 9 further comprising error correction circuitry that performs error correction across the at least one of the memory channels.

11. The data storage apparatus of claim 1 further comprising an interface between the integrated storage controller and a host system.

12. The data storage apparatus of claim 11 wherein the interface is a network interface card.

13. The data storage apparatus of claim 12 wherein the network interface card is incorporated in the integrated storage controller.

14. An integrated storage controller for controlling a plurality of drive units, where each drive unit includes a plurality of memory channels, and a plurality of storage medium controllers, each storage medium controller addressing at least one of the memory channels, and each of the storage medium controllers being incapable of performing file system operations; the integrated storage controller comprising:
a central processing unit;
a host interface; and
at least one storage medium interface for communicating with the plurality of storage medium controllers; wherein:
the integrated storage controller performs all file system operations of the data storage apparatus.

15. The integrated storage controller of claim 14 wherein the at least one storage medium interface comprises a plurality of storage medium interfaces.

16. The integrated storage controller of claim 14 further comprising error correction circuitry that performs error correction across all of the memory channels.

17. The integrated storage controller of claim 16 wherein the error correction circuitry includes redundancy circuitry, whereby the data storage apparatus is operable in case of failure of one of the memory channels.

18. The integrated storage controller of claim 14, wherein the integrated storage controller performs wear-leveling across all of the memory channels.

19. The integrated storage controller of claim 14 further comprising a working memory interface for connecting the central processing unit to a working memory.

20. The integrated storage controller of claim 14 further comprising an interface for connection to a host system.

21. The integrated storage controller of claim 20 wherein the interface is a network interface card.

22. A method of operating data storage apparatus having a plurality of drive units, each of the drive units including a plurality of memory channels, and a plurality of storage medium controllers, each storage medium controller addressing at least one of the memory channels, each of the storage medium controllers being incapable of performing file system operations; the method comprising:
performing all file system operations of the data storage apparatus in an integrated storage controller connected to all of the drive units; and
performing, in the integrated storage controller, error correction across all of the memory channels.

23. The method of claim 22 further comprising performing, in each storage medium controller, error correction across all of the at least one of the memory channels.

24. The method of claim 22 wherein the performing, in the integrated storage controller, error correction across all of the memory channels, comprises implementing redundancy, whereby the data storage apparatus is operable in case of failure of one of the memory channels.

25. The method of claim 22 further comprising performing, in the integrated storage controller, wear-leveling across all of the memory channels.
